(19) United States
(12) Patent Application Publication
(10) Pub. No.: US 2003/0093280 A1
(43) Pub. Date: May 15, 2003

(54) Method and apparatus for synthesising an emotion conveyed on a sound

(76) Inventor: Pierre-Yves Oudeyer, Paris (FR)

Correspondence Address: FROMMER LAWRENCE & HAUG LLP, 745 FIFTH AVENUE, NEW YORK, NY, 10151, US

(21) Appl. No.: 10/192,974

(22) Filed: Jul. 11, 2002

(30) Foreign Application Priority Data
Jul. 13, 2001 (EP) 01 401 880.8

(51) Int. Cl. G10L 13/06

(52) U.S. Cl. 704/266

(57) ABSTRACT

An emotion conveyed on a sound is synthesised by selectively modifying elementary sound portions (S) thereof prior to delivering the sound through an operator application step (S10, S16, S20) in which at least one operator (OP, OD; OI) is selectively applied to the elementary sound portions (S) to impose a specific modification in a characteristic, such as pitch and/or duration in accordance with an emotion to be synthesised.

This can be achieved by applying at least one operator (OIrs, OIfs, OIsu, OIsd) to modify an intensity characteristic of an elementary sound portion, and/or an operator (OPrs, OPfs) for selectively causing the time evolution of the pitch of an elementary sound portion (S) to rise or fall according to an imposed slope characteristic (Prs, Pfs), and/or an operator (OPsu, OPsd) for selectively causing the time evolution of the pitch of an elementary sound portion (S) to rise or fall uniformly by a determined value (Psu, Psd), and/or an operator (ODd, ODc) for selectively causing the duration (t1) of an elementary sound portion (S) to increase or decrease by a determined value (D).

The invention relates to the field of voice synthesis or reproduction with controllable emotional content. More particularly, the invention relates to a method and device for controllably adding an emotional feel to a synthesised or sampled voice or, in view of providing a more natural or interesting delivery to talking or other sound emitting objects.

It is well known that the human voice is greatly influenced by emotion, either intentionally (e.g. by raising intensity to express anger) or unintentionally as a physiological response to the emotion or its cause: dry mouth, modified breathing pattern etc. These emotion-induced changes in voice and delivery add a subjective dimension to the information conveyed by the speaker and are useful to communicate successfully.

With the arrival of ever more complex objects that communicate by speech or uttered sounds, such as pet robots and the like which imitate human or animal behaviour, there is a growing need to dispose of technical means for also giving the impression of an emotion in their communication. Indeed, in a robot apparatus, for instance, a function of uttering a voice with an emotional expression is very effective to establish a good relationship between the robot apparatus and a human user. In addition to the enhancement in good relationship, expression of satisfaction or dissatisfaction can also stimulate the human user and give a motivation to him/her to respond or react to the emotional expression of the robot apparatus. In particular, such a function is useful in a robot having a learning capability.

The possibility of adding an emotion content to delivered speech is also useful for computer aided systems which read texts or speeches for persons who cannot read for one reason or another. Examples of such systems which readout novels, magazine articles, or the like and whose listening pleasure ability to focus attention can be enhanced if the reading voice can simulate emotions.

Three general approaches are known in the prior art to imitate emotions in speech delivery.

A first approach, which is the most complicated and probably the less satisfactory, is based on linguistic theories for determining intonations.

A second uses databases containing phrases tinted with different emotions produced by human speakers. To produce a specific phrase with the desired emotion content, the nearest- sounding phrase with the corresponding emotion content is extracted from the database. Its pitch contour is measured and copied to apply on the selected phrase to be produced. This approach is mainly useable when the database and produced phrases have very close grammatical structures. It is also difficult to implement.

A third approach, which is recognised as being the most effective, consists in utilising voice synthesisers which sample from a database of recorded human voices. These synthesisers operate by concatenating phonemes or short syllables produced by human voice to resynthesise sound sequences that correspond to a required spoken message. Instead of containing just neutral human voices, the database comprises voices spoken with different emotions. However, these systems have two basic limitations. Firstly, they are difficult to implement, and secondly, the databases are usually created by voices from different persons, for practical reasons. This can be disadvantageous when listeners expect the synthesised voice always to appear to be coming from a same speaker.

There is also a voice synthesis software device which allows a certain number of parameters to be controlled, but within a closed architecture which is not amenable for developing new applications.

In view of the foregoing, the invention proposes a new approach which is easy to implement, provides convincing results and is easy to parameterise.

The invention also makes it possible to reproduce emotions in synthesised speech for meaningful speech contents in a recognisable language both in a naturally sounding voice and in deliberately distorted, exaggerated voices, for example as spoken by cartoon characters, talking animals or non-human animated forms, simply by playing on parameters. The invention is also amenable to imparting emotions on voices that deliver meaningless sounds, such as babble.

More particularly, the invention according to a first aspect proposes a method of synthesising an emotion conveyed on a sound, by selectively modifying at least one elementary sound portion thereof prior to delivering the sound,

characterised in that the modification is produced by an operator application step in which at least one operator is selectively applied to at least one elementary sound portion to impose a specific modification in a characteristic thereof, such as pitch/or duration, in accordance with an emotion to be synthesised.

The operator application step preferably comprises forming at least one set of operators, the set comprising at least one operator to modify a pitch characteristic and/or at least one operator to modify a duration characteristic of the elementary sound portions.

It can also be envisaged to provide an operator application step for applying at least one operator to modify an intensity characteristic of the elementary sound portions.

In the embodiment, there is provided a step of parameterising at least one operator with a numerical parameter affecting an amount of a the specific modification associated to the operator in accordance with an emotion to be synthesised.

Advantageously, the operator application step comprises applying:

an operator for selectively causing the time evolution of the pitch of an elementary sound portion to rise or fall according to an imposed slope characteristic; and/or

an operator for selectively causing the time evolution of the pitch of an elementary sound portion to rise or fall uniformly by a determined value; and/or.

an operator for selectively causing the duration of an elementary sound portion to increase or decrease by a determined value.

The method can comprise a universal phase in which at least one the operator is applied systematically to all elementary sound portions forming a determined sequence of the sound.

In this phase, at least one operator can be applied with a same operator parameterisation to all elementary sound portions forming a determined sequence of the sound.

The method can comprise a probabilistic accentuation phase in which at least one the operator is applied only to selected elementary sound portions chosen to be accentuated.

The selected elementary sound portions can selected by a random draw from candidate elementary sound portions, preferably to select elementary sound portions with a probability which is programmable.

The candidate elementary sound portions can be:

all elementary sound portions when a source of the portions does not prohibit an accentuation on some data portions, or

only those elementary sound portions that are not prohibited from accentuation when the source prohibits accentuations on some data portions.

A same operator parameterisation may be used for the at least one operator applied in the probabilistic accentuation phase.

The method can comprise a first and last elementary sound portions accentuation phase in which at least one operator is applied only to a group of at least one of elementary sound portion forming the start and end of said determined sequence of sound, the latter being e.g. a phrase.

The elementary portions of sound may correspond to a syllable or to a phoneme.

The determined sequence of sound can correspond to intelligible speech or to unintelligible sounds.

The elementary sound portions can be presented as formatted data values specifying a duration and/or at least one pitch value existing over determined parts of or all the duration of the elementary sound.

In this case, the operators can act to selectively modify the data values.

The method may performed without changing the data format of the elementary sound portion data and upstream of an interpolation stage, whereby the interpolation stage can process data modified in accordance with an emotion to be synthesised in the same manner as for data obtained from an arbitrary source of elementary sound portions.

According to a second aspect, the invention provides a device for synthesising an emotion conveyed on a sound, using means for selectively modifying at least one elementary sound portion thereof prior to delivering the sound,

characterised in that the means comprise operator application means for applying at least one operator to at least one of the elementary sound portion to impose a specific modification in a characteristic thereof in accordance with an emotion to be synthesised.

The optional features presented above in the context of the method (first aspect) can apply mutatis mutandis to the device according to the second aspect.

According to a third aspect, the invention provides a data medium comprising software module means for executing the method according to the first aspect mentioned above.

The invention and its advantages shall be better understood from the reading the following description of its preferred embodiments, given purely as non-limiting examples, with reference to the appended drawings, in which:

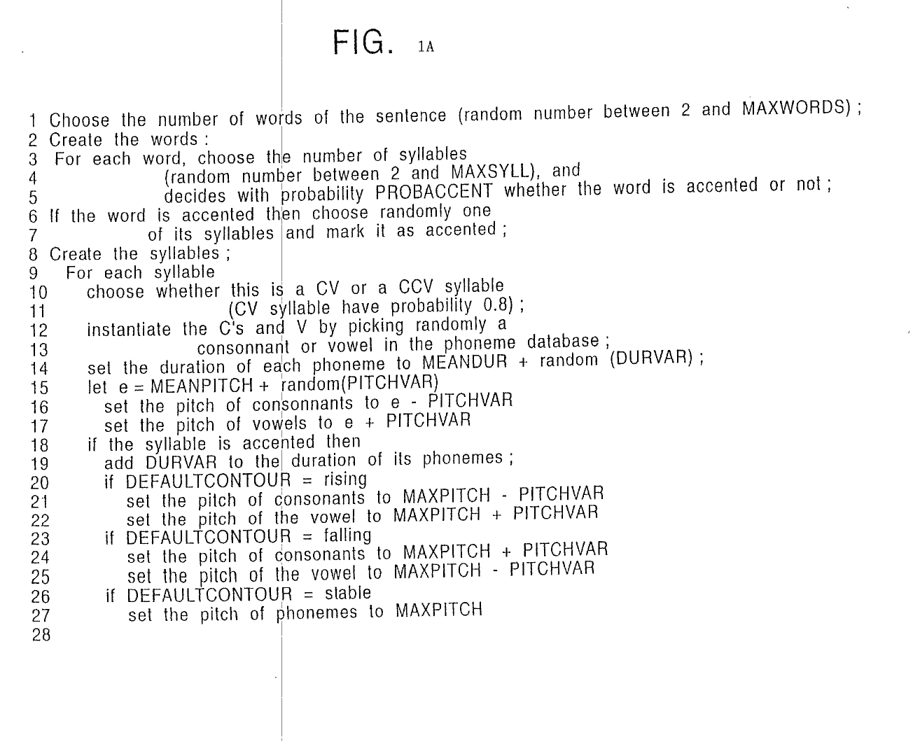

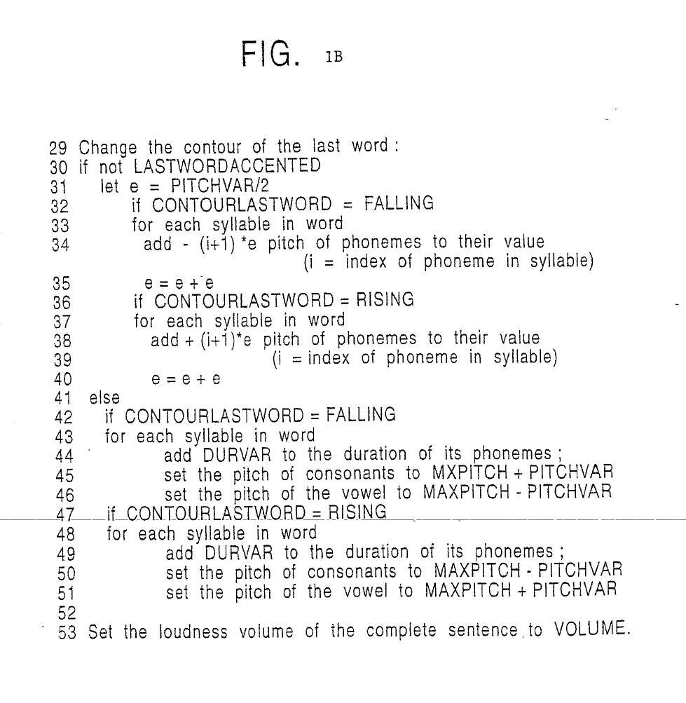

FIGS. 1a and 1b is an example on a program for producing a sentence to be uttered in accordance with a procedure described in an earlier European patent of the applicant, from which the present claims priority,

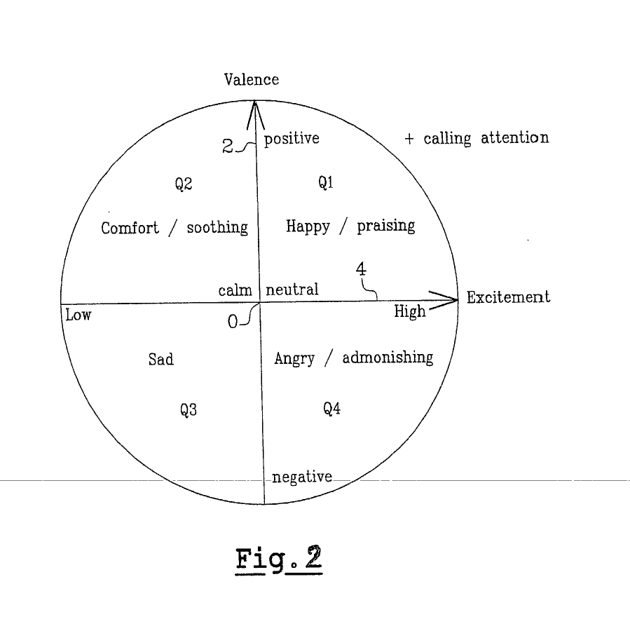

FIG. 2 is a chart showing how basic emotions can be position on orthogonal axes representing respectively valence and excitement,

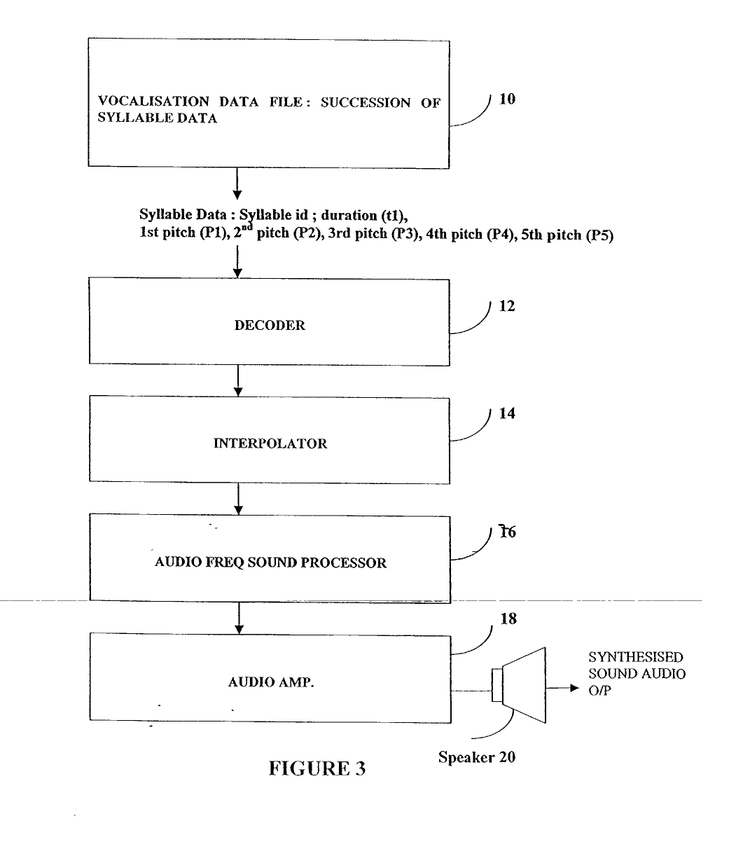

FIG. 3 is a block diagram showing functional units involved in a voice synthesis system to which the present invention can be applied,

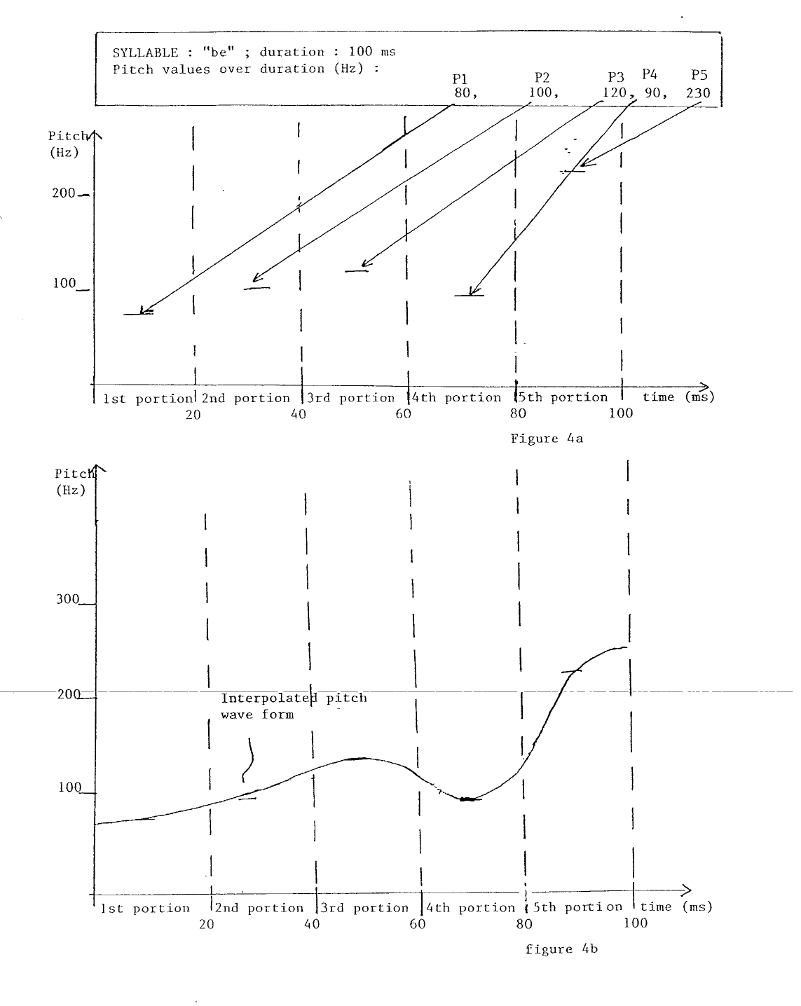

FIG. 4a is an illustration of a typical data structure for specifying a syllable to be exploited by the system of FIG. 3,

FIG. 4b is an illustration indicating how a pitch signal contour is generated after interpolation from the data presented in FIG. 4a,

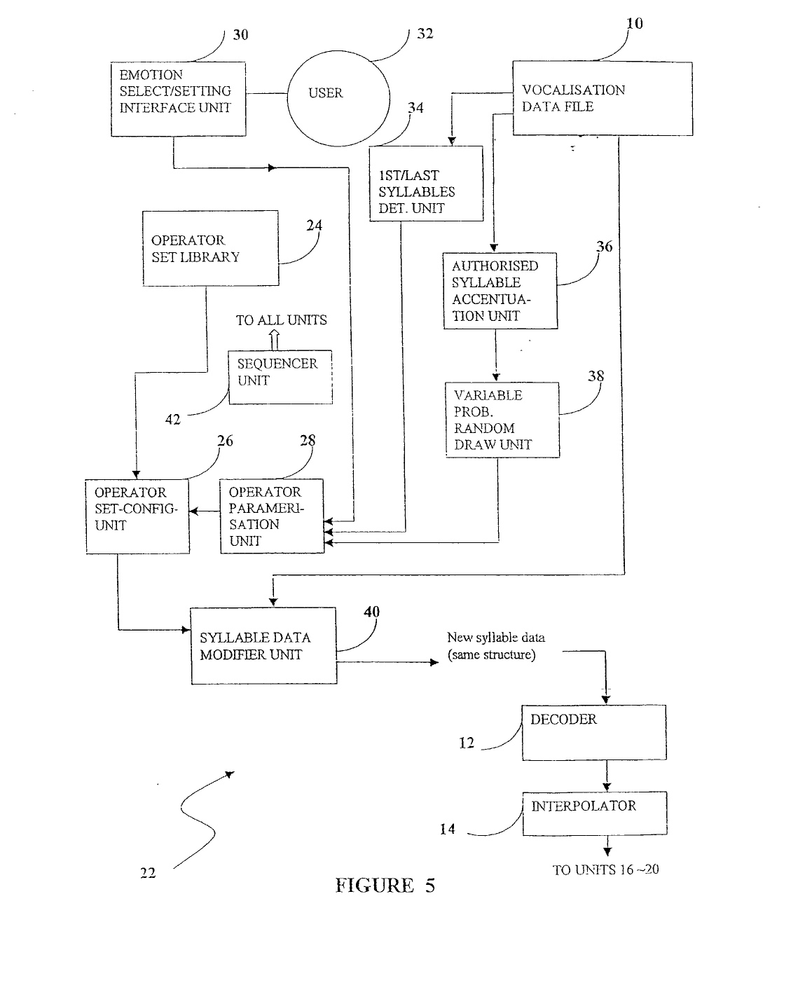

FIG. 5 is a block diagram of an operator-based emotion generating system according to an preferred embodiment of the invention,

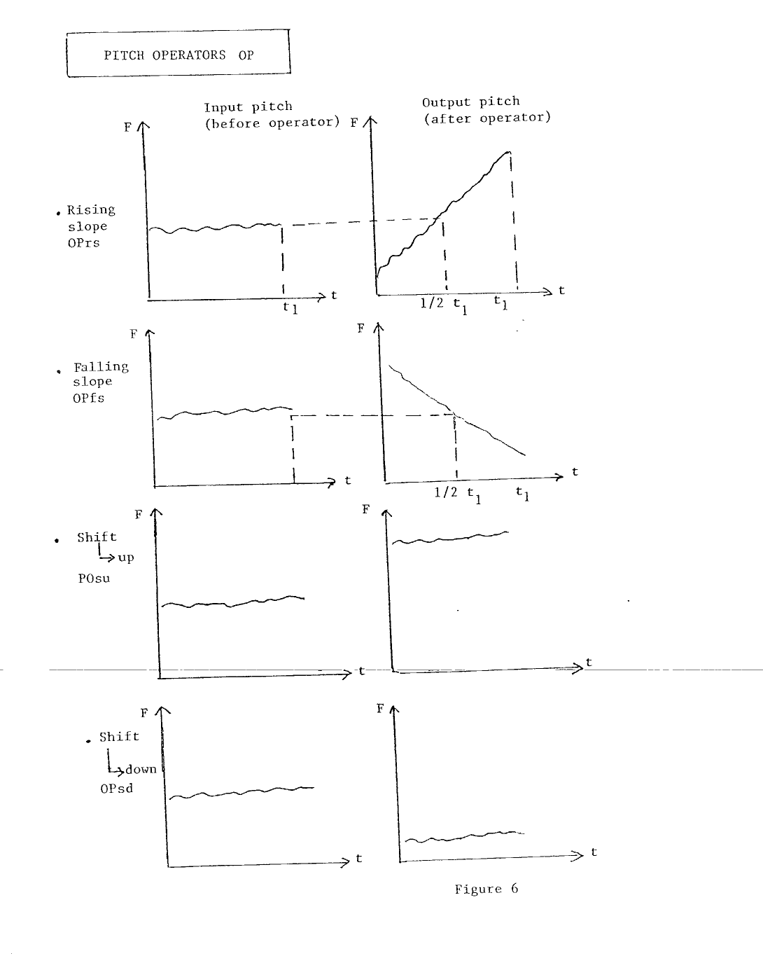

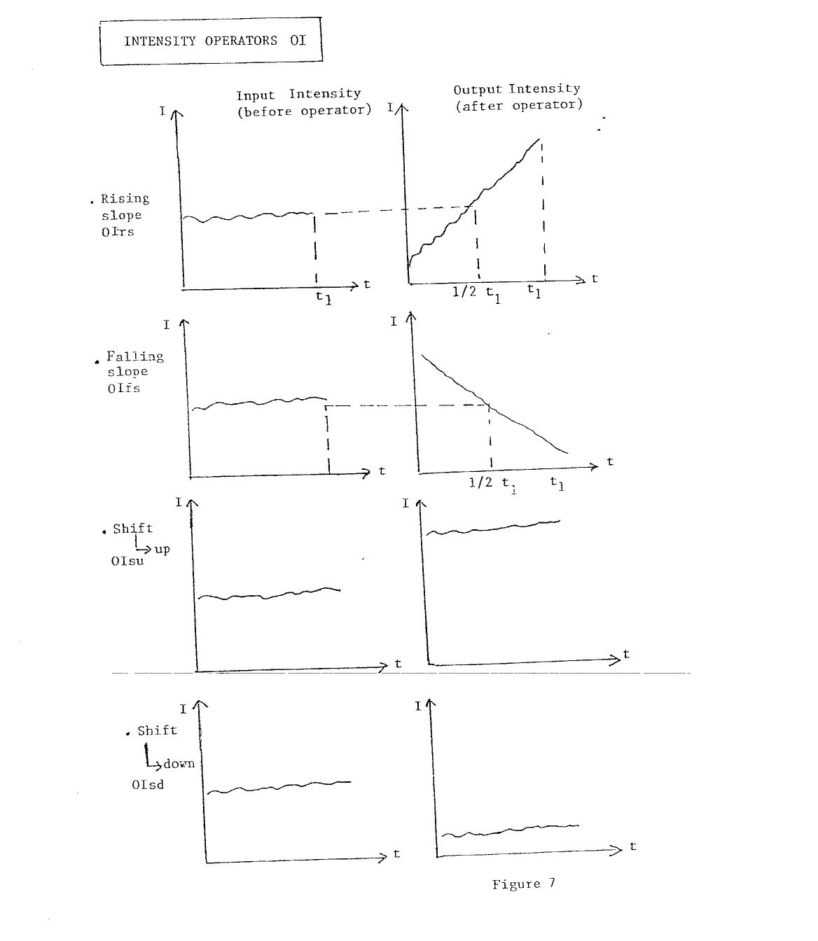

FIG. 6 is a diagrammatic representation of pitch operators used by the system of FIG. 5,

FIG. 7 is a diagrammatic representation of intensity operators which may optionally be used in the system of FIG. 5,

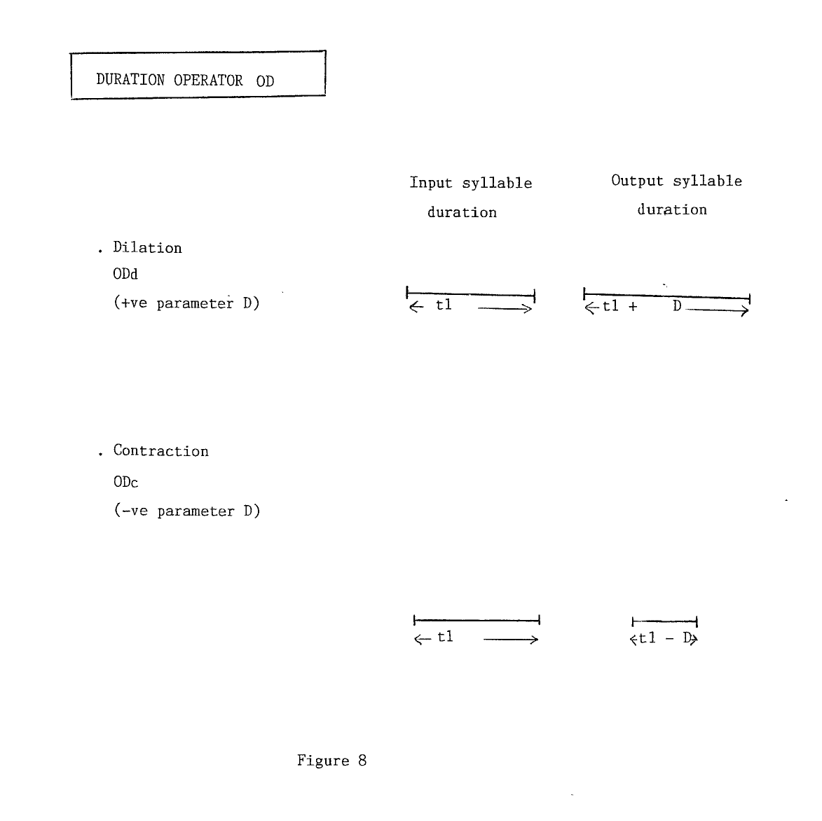

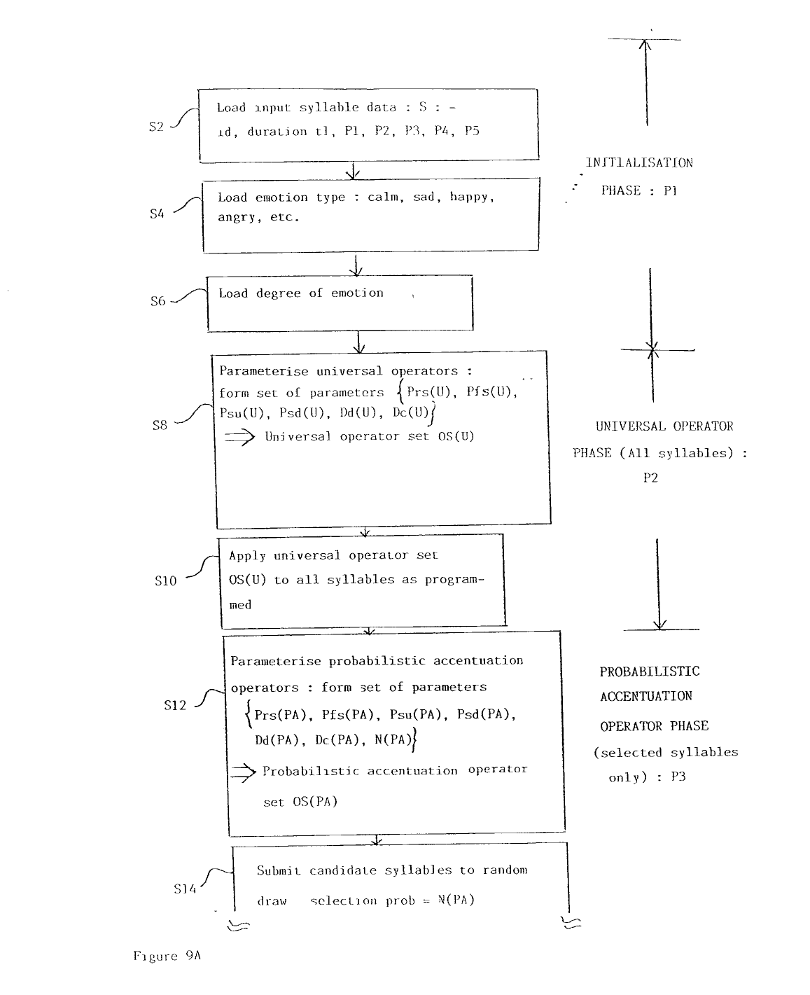

FIG. 8 is a diagrammatic representation of duration operators used by the system of FIG. 5, and

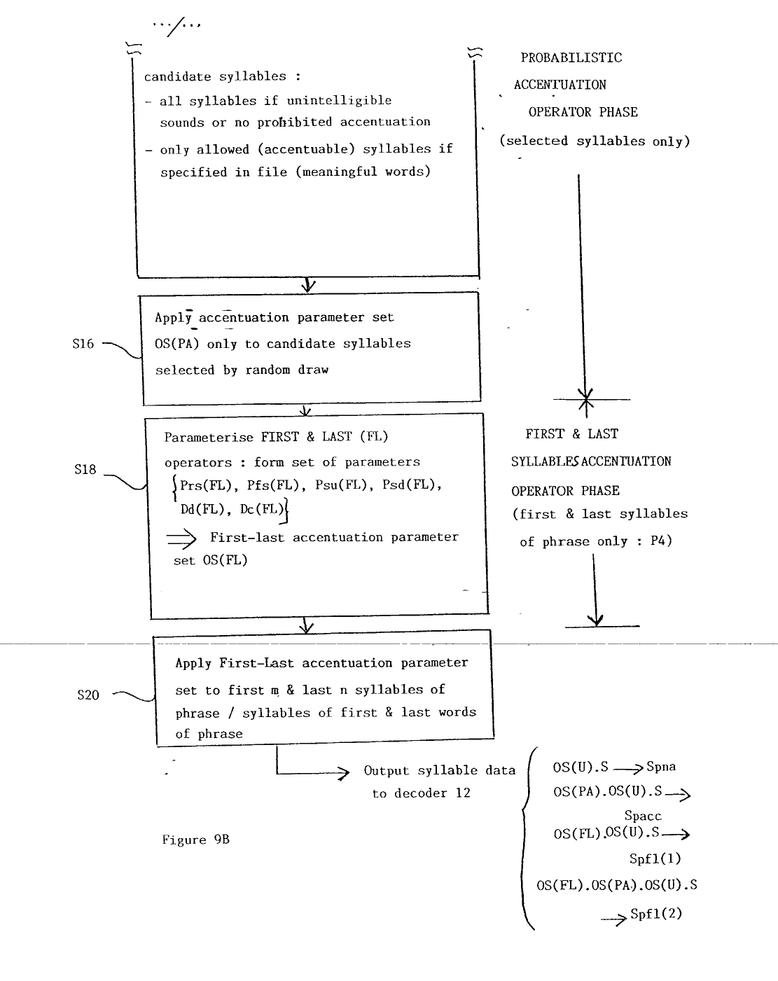

FIG. 9 is a flow chart of an emotion generating process performed on syllable data by the system of FIG. 5.

The invention is a development from work that forms the subject of earlier European patent application number 01 401 203.3 of the Applicant, filed on May 11, 2001 and to which the present application claims priority.

The above earlier application concerns a voice synthesis method for synthesising a voice in accordance with information from an apparatus having a capability of uttering and having at least one emotional model. The method here comprises an emotional state discrimination step for discriminating an emotional state of the model of the apparatus having a capability of uttering, a sentence output step for outputting a sentence representing a content to be uttered in the form of a voice, a parameter control step for controlling a parameter for use in voice synthesis, depending upon the emotional state discriminated in the emotional state discrimination steps, and a voice synthesis step for inputting, to a voice synthesis unit, the sentence output in the sentence output step and synthesising a voice in accordance with the controlled parameter.

Typically, the voice in the earlier application has a meaningless content.

When the emotional state of the emotional model becomes greater than a predetermined value, the sentence output step outputs the sentence and supplies it to the voice synthesis unit.

The sentence output step outputs can output a sentence obtained at random for each utterance and supply it to the voice synthesis unit.

The sentences can include a number of phonemes and the parameter can include pitch, a duration, and an intensity of a phoneme.

The apparatus having the capability of uttering can be an autonomous type robot apparatus which acts in response to supplied input information. The emotion model can be such as to cause the action in question. The voice synthesis method can then further include the step of changing the state of the emotion model in accordance with the input information thereby determining the action.

The above earlier application also covers an apparatus which can carry out the above method.

The above earlier application moreover covers an autonomous type, e.g. comprising a robot, which acts in accordance with supplied input information, comprising an emotional model which causes the action in question, emotional state discrimination means for discriminating the emotional state of the emotional model, sentence output means for outputting a sentence representing a content to be uttered in the form of a voice, parameter control means for controlling a parameter used in voice synthesis depending upon the emotional state discriminated by the emotional state discrimination means, and voice synthesis means which receive the sentence output from the sentence output means and resynthesises a voice in accordance with the controlled parameter.

Before describing embodiments of the invention in detail, the following section summarises preliminary investigations by the Applicant, aspects of which are covered by the above-mentioned earlier copending European patent application.

### Preliminary Investigations

More aspects pertaining to the above earlier copending European patent application on which priority is claimed is presented below, up to the end of the section entitled “Validation with human subjects”. Recent years have been marked by the increasing development of personal robots, either used as new educational technologies (Druin A., Hendler J. (2000) “Robots for kids: exploring new technologies for learning”, Morgan Kauffman Publishers) or for pure entertainment (Fujita M., Kitano H. (1998) “Development of an autonomous quadruped robot for robot entertainment”, Autonomous Robots, 5; Kusahara. M. “The art of creating subjective reality: an analysis of Japanese digital pets, in Boudreau E., ed., in Artificial Life 7 Workshop Proceedings, pp. 141-144). Typically, these robots look like familiar pets such as dogs or cats (see for e.g. the Sony AIBO robot), or sometimes take the shape of young children such as the humanoids SDR3-X (Sony).

The interactions with these machines are to be radically different with the way humans interact with traditional computers. So far humans had the habit of learning to use very unnatural conventions and media such as keyboards or dialog windows, and had to have some significant knowledge about the way computers work to be able to use them. Opposite to that, personal robots should try themselves to learn the natural conventions (such as natural language or social rules like politeness) and media (such as speech or touch) that humans have been using for thousands of years.

Among the capabilities that these personal robots need, one of the most basic is the ability to have a grasp over human emotions (Picard R. (1997) Affective Computing, MIT Press.), and in particular they should to be able both to recognise human emotions and express their own emotions. Indeed, not only emotions are crucial to human reasoning, but they are central to social regulation (Halliday M. (1975) “Learning how to mean: explorations in the development of language, Elsevier, N.Y. and in particular to the control of dialog flows. Emotional communication is at the same time primitive enough and efficient enough so that humans use it a lot when interacting with pets, in particular when taming them. This is also certainly what allows children to bootstrap language learning (Halliday, 1975 cited supra) and should be inspiring to teach robots natural language.

Apart from language, humans express their emotions to others in two main ways: the modulation of facial expression (Ekman, P. (1982) “Emotions in the human face”, Cambridge University Press, Cambridge.) and the modulation of the intonation of the voice (Banse, R. and Sherer, K. R., (1996) “Acoustic profiles in vocal emotion expression”, Journal of Personality and Social Psychology, 70(3): 614-636.). Whereas research on automated recognition of emotions in facial expressions is now very rich (A. Samal, P. Iyengar (1992) “Automatic recognition and analysis of human faces and facial expression: a survey”. Pattern Recognition, 25(1):65--77.), research dealing with the speech modality, both for automated production and recognition by machines, has been active only for very few years (Bosh L. T. (2000) “Emotions: what is possible in the ASR framework ?”,in Proceedings of the ISCA Workshop on Speech and Emotion.).

The Applicants research consisted in providing to a baby-like robot means to express emotions vocally. Unlike most of existing work, the Applicant has also studied the possibility of conferring emotions in cartoon-like meaningless speech, which has different needs and different constraints than, for example trying to produce naturally sounding adult-like normal emotional speech. For example, a goal was that emotions can be recognised by people with different cultural or linguistic background. The approach uses concatenative speech synthesis and the algorithms is simpler and completely specified than in those used in other studies, such as conducted by Breazal.

### The Acoustic Correlates of Emotions in Human Speech

To achieve this goal, it was first determined if there are some reliable acoustic correlates of emotion/affect in the acoustic characteristics of a voice signal. A number of researchers have already investigated this question (Fairbanks 1940, Burkhardt F., Sendlmeier W., (2000) “Verification of acoustical correlates of emotional speech using formant-synthesis”, in Proceedings of the ISCA Workshop in Speech and Emotion., Banse R. and Sherer K. R. 1996 “Acoustic profiles in vocal emotion expression”, Journal of Personality and Social Psychology, 70(3):614-636).

Their results agree on the speech correlates that come from physiological constraints, and that correspond to broad classes of basic emotions, but disagree and are unclear when one looks at the differences between the acoustic correlates of for instance fear and surprise or boredom and sadness. Indeed, certain emotional states are often correlated with particular physiological states (Picard 1997 “Affective Computing”, MIT Press) which in turn have quite mechanical and thus predictable effects on speech, especially on pitch, (fundamental frequency F0) timing and voice quality. For instance, when one is in a state of anger, fear or joy, the sympathetic nervous system is aroused, the heart rate and blood pressure increase, the mouth becomes dry and there are occasional muscle tremors. Speech is then loud, fast and enunciated with strong high frequency energy. When one is bored or sad, the parasympathetic nervous system is aroused, the heart rate and blood pressure decrease and salivation increases, producing speech that is slow, low-pitched and with little high frequency energy (Breazal, 2000).

Furthermore, the fact that these physiological effects are rather universal means that there are common tendencies in the acoustical correlates of basic emotions across different cultures. This has been precisely investigated in studies like (Abelin A, Allwood J., (2000) “Cross-linguistic interpretation of emotional prosody”, in Proceedings of the ISCA Workshop on Speech and Emotion.) or (Tickle A. (2000) “English and Japanese speaker's emotion vocalisations and recognition: a comparison highlighting vowel quality”, ISCA Workshop on Speech and Emotion, Belfast 2000.) who made experiments in which American people had to try to recognise the emotion of either another American or a Japanese person only using the acoustic information (the utterance were meaningless, so there was no semantic information).

Japanese people were likewise asked to try to decide which emotions other Japanese or American people were trying to convey. Two results came out of the study: 1) there was only little difference between the performance of trying to detect the emotions conveyed by someone speaking the same language or the other language, and this is true for Japanese as well as for American subjects; 2) subjects were far from perfect recognisers in the absolute: the best recognition score was 60 percent. (This result could be partly explained by the fact that subject were asked to utter nonsense utterances, which is quite unnatural, but is confirmed by studies asking people utter semantically neutral but meaningful sentences (Burkhart and Sendlmeier 2000) cited supra).

The first result indicates that the goal of making a machine express affect both with meaningless speech and in a way recognisable by people from different cultures with the accuracy of a human speaker is attainable in theory. The second result shows that a perfect result cannot be expected. The fact that humans are not so good is mainly explained by the fact that several emotional state have very similar physiological correlates and thus acoustic correlates. In actual situations, humans solve the ambiguities by using the context and/or other modalities. Indeed, some experiments have shown that the multi-modal nature of the expression of affect can lead to a MacGurk effect for emotions (Massaro D., (2000) “Multimodal emotion perception: analogous to speech processes”, ISCA Workshop on Speech and Emotion, Belfast 2000.) and that different contexts may lead people to interpret the same intonation as expressing different emotions for each context (Cauldwell R. (2000) “Where did the anger go ? The role of context in interpreting emotions in speech”, ISCA Workshop on Speech and Emotion.). These findings indicate that it is not necessary to have a machine generate utterances that make fine distinctions; only the most basic affects should be investigated.

A number of experiments using computer based techniques of sound manipulation have been conducted to explore which particular aspect of speech reflect emotions with most saliency. (Murray I. R., Arnott J. L., (1993) “Towards a simulation of emotion in synthetic speech: a review of the literature on human vocal emotion, JASA 93(2), pp. 1097-1108.; Banse and Scherer, 1996; Burkhardt and Sendlmeier, 2000; Williams and Stevens, 1972, cited supra) basically all agree that the most crucial aspects are those related to prosody: the pitch (or f0) contour, the intensity contour and the timing of utterances. Some more recent studies have shown that voice quality (Gobl C., Chasaide A. N. (2000) “Testing affective correlates of voice quality through analysis and resynthesis”, in Proceedings of the ISCA Workshop on Emotion and Speech.) and certain co-articulatory phenomena (Kienast M., Sendlmeier W. (2000) “Acoustical analysis of spectral and temporal changes in emotional speech”, in Proccedings of the ISCA Workshop on Emotion and Speech.) are also reasonably correlated with certain emotions.

### The Generation of Cartoon Emotional Speech

In the above context, the Applicant conducted considerable research into the generation of cartoon emotional speech. (However, the scope of the present invention covers all forms of speech, including natural human speech.) The goal was quite different from that of most of existing work in synthetic emotional speech. Whereas traditionally (see Cahn J. (1990) “The generation of affect in synthesized speech”, Journal of the I/O Voice American Society, 8:1-19., Iriondo I., et al. (2000) “Validation of an acoustical modelling of emotional expression in Spanish using speech synthesis Techniques”, in Proceedings of ISCA workshop on speech and emotion., Edgington M. D., (1997) “Investigating the limitations of concatenative speech synthesis”, in Proceedings of EuroSpeech'97, Rhode, Greece., Iida et al. 2000), the aim was to produce adult-like naturally occurring emotional speech, the target of the study was to provide to a young creature the ability to express its emotions in an exaggerated/cartoon manner, while using nonsense words (this is necessary because experiments were conducted with robots which had to learn a language: this pre-linguistic ability to use only intonation to express basic emotions serves to bootstrap learning. The speech had to sound lively, be not repetitive, and similar to the babbling of infants.

Additionally, the algorithms had to be as simple as possible with as few parameters as possible: in brief, what was sought was the minimum that allows to transmit emotions with prosodic variations. Also, the speech had to be both of high quality and computationally cheap to generate (robotic creatures have usually only very scarce resources). For these reasons, it was decided to use as a basis a concatenative speech synthesizer (Dutoit T. and Leich H. (1993) “MBR-PSOLA: Text-to-Speech synthesis based on an MBE re-synthesis of the segments database, Speech Communication.), the MBROLA software freely available on the web at web page :http://tcts.fpms.ac.be/synthesis/mbrola.html}, which is an enhancement of more traditional PSOLA techniques (it produces less distortions when pitch is manipulated). The price of quality is that very little control is possible over the signal, but this is compatible with a need for simplicity.

Because of all these constraints, it was chosen to investigate so far only five emotional states, corresponding to calm and one for each of the four regions defined by the two dimensions of arouseness and valence: anger, sadness, happiness, comfort.

As said above, existing work has concentrated on adult-like naturally sounding emotional speech, and most of projects have tackled only one language. Many of them (cf. Cahn, 1990 “The generation of affect in synthesised speech”, Journal of the I/O Voice American Society, 8:1-19; Murray E., Arnott J. L., (1995) “Implementation and testing of a system for producing emotion-by-rule in synthetic speech”, Speech Communication, 16(4), pp. 369-390; Burkhardt and Sendlmeier, 2000 cited supra) have used formant synthesis as a basis, mainly because it allows detailed and rich control of the speech signal: one can control voice quality, pitch, intensity, spectral energy distributions, harmonics-to-noise ratio or articulatory precision which allows to model many co-articulation effects occurring in emotional speech. The drawbacks of formant synthesis are that quality of the produced speech remains not satisfying (voices are often still quite not natural). Furthermore, the algorithms developed in this case are complicated and require many parameters to be controlled, which makes their fine tuning quite impractical (see Cahn, 1990 cited supra for a discussion). Unlike these works, (Breazal, 2000 “Sociable machines: expressive social exchange between humans and robots, PhD thesis, MIT AI Lab.) has described for a robot “Kismet” that allows it to produce meaningless emotional speech. However, like the work of Cahn, it relies heavily on the use of a commercial speech synthesiser whose many parameters are often high level (for example, specification of the pitch baseline of a sentence) and implemented in an undocumented manner. As a consequence, this is approach is hardly reproducible if one wants to use another speech synthesis system as the basis. Conversely, the algorithm used by the Applicant and described below is completely specified, and can be used directly with any PSOLA-based system (besides, the one actually used can be freely downloaded, see above).

Another drawback of the work of Breazal is that the synthesiser used is formant based, which does not correspond to the envisaged constraints.

Because of their very superior quality, concatenative speech synthesisers have gained popularity in the recent years, and some researchers have tried to use them to produce emotional speech. This is a challenge and significantly more difficult than with formant synthesis, since only the pitch contour, the intensity contour and the duration of phonemes can be controlled (and even so, there are narrow constraints over this control). To the Applicant's knowledge, two approaches have been presented in the literature. The first one, as for example described in (Iida et al., 2000 “A speech synthesis system with emotion for assisting communication”, ISCA Workshop on Speech and Emotion), uses one speech database for each emotion as the basis of the pre-recorded segments to be concatenated in the synthesis. This gives satisfying results, but is quite impractical if one wants for example to change the voice or to add new emotions or even to control the degree of emotions.

The second approach (see for example Edgington M. D. “Investigating the limitations of concatenative speech synthesis”, Proceedings of EuroSpeech'97, Rhode, Greece) in making databases of human produced emotional speech, computing the pitch contours and intensity contours, and applying them to sentences to be generated. This brings some problems of alignments, partially solved using syntactic similarities between sentences. However, Edgington showed that this method gave quite unsatisfactory results (speech ends by being unnatural and emotions are not very well recognised by human listeners).

Finally, these two methods cannot be readily applied to cartoons, since there would be great difficulties making speech databases of exaggerated/cartoon baby voices.

The approach adopted in the invention is—from an algorithmic point of view—completely generative (it does not rely on the recording human speech that would serve as input), and uses concatenative speech synthesis as a basis. It has been found to express emotions as efficiently as with formant synthesis, yet with simpler controls and a more life-like signal quality.

### A Simple and Complete Algorithm

An algorithm developed by the Applicant consists in generating a meaningless sentence and specifying the pitch contour and the durations of phonemes (the rhythm of the sentence). For sake of simplicity, there is specified only one target per phoneme for the pitch, which can often be sufficient.

It is possible to provide fine control over the intensity contour, but this is not always necessary, since manipulating the pitch can create the auditory illusion of intensity variations. Thus, good results can be achieved with only control of the overall volume of sentences.

The program generates a file as shown in table I below, which is fed into the MBROLA speech synthesiser.

TABLE 1
example of a file generated by a speech synthesis
program

1 448 10 150 80 158 ;; means : phoneme “1” duration 448 ms,

;; at 10 percent of 448 ms

;; try to reach 130 Hz, at 80 percent
;; try to reach 158 Hz

9″ 557 80 208
b 131 80 179
c 77 20 200 80 229
o 405 80 169
o 537 80 219
v 574 80 183.0
a 142 80 208.0
n 131 80 221.0
i 15 80 271.0
H 117 80 278.0
E 323 5 200 300 300 80 378.0 100 401

The idea of the algorithm is to initially generate a sentence composed of random words, each word being composed of random syllables (of type CV or CCV). Initially, the duration of all phonemes is constant and the pitch of each phoneme is constant equal to a pre-determined value (to which is added noise, which is advantageous to make the speech to sound natural. Many different kinds of noise were experimented, and it was found the type of noise used does not make significant differences; for the perceptual experiment reported below, Gaussian noise was used). The sentence's pitch and duration information are then altered so as to yield a particular affect. Distortions consist in deciding that a number of syllables become stressed, and in applying a certain stress contour on these syllables as well as some duration modifications. Also, to all syllables are applied a certain default pitch contour and duration deformation.

For each phoneme, there is given only one pitch target fixed at 80 percent of the duration of the phoneme.

The above-cited European patent application serving as a priority for the present application presents in FIGS. 3 and 4 a program for producing a sentence to be uttered by means of a voice synthesis based on the above algorithm. This same program is presented here in FIGS. 1a and 1b, the latter being the continuation of the former. (Words in capital letters denote parameters of the algorithm that need to be set for each emotion).

A few remarks can be made concerning this algorithm. First, it is useful to have words instead of just dealing with random sequences of syllables because it avoids to put too often accents on adjacent syllables. Also, it allows to express more easily the operations performed on the last word. Typically, the maximum number of words in a sentence (MAXWORDS) does not depend on the particular affect, but rather is a parameter than can be freely varied. A key aspect of this algorithm resides the stochastic parts: on the one hand, it allows to produce each time a different utterance for a given set of parameters (mainly by virtue of the random number of words, the random constituents of phonemes of syllables or the probabilistic attribution of accents); on the other hand, details like adding noise to the duration and pitch of phonemes (see line 14 and 15 of the program shown in FIG. 1, where random(n) means “random number between 0 and n”) are advantageous for the naturalness of the vocalisations (if it remains fixed, then one perceives clearly that this is a machine talking). Finally, accents are implemented only by changing the pitch and not the loudness. Nevertheless, it gives satisfying results since, in human speech, an increase in loudness is correlated to an increase in pitch. Of this sometimes requires to exaggerate the pitch modulation, but this is fine since, as explained earlier, a goal is not always to reproduce faithfully the way humans express emotions, but to produce a lively and natural caricature of the way they express emotions (cartoon-like).

Finally, a last step is added to the algorithm in order to get a voice typical of a young creature: the sound file sampling rate is overridden by setting it to 30000 or 35000 Hz as compared to the 16000 Hz produced by MBROLA (this is equivalent to playing the file quicker). Of course, in order to keep the speech rate normal, it is initially made slower in the program sent to MBROLA. Only the voice quality and pitch are modified. This last step is preferable, since no child voice database exists for MBROLA (which is understandable since making it would be difficult with a child). Accordingly, a female adult voice was chosen.

Having in details the algorithm, see table II below gives examples of values of the parameters obtained for 5 affects: calm, anger, sadness, happiness, comfort.

These parameters were obtained by first looking at studies describing the acoustic correlates of each emotions (e.g. Murray and Arnott 1993, Sendlmeier and Burkhartd 2000, cited supra), then deducing some coherent initial value for the parameters and modifying them by hand and trial and error until they gave a satisfying result. Evaluation of the quality is given in next section.

TABLE II
parameter values for different emotions

| | Calm | Anger | Sadness | Comfort | Happiness |
|---|---|---|---|---|---|
| LASTWORDACCENTED | NIL | NIL | NIL | TRUE | TRUE |
| MEANPITCH | 280 | 450 | 270 | 300 | 400 |
| PITCHVAR | 10 | 100 | 30 | 50 | 100 |
| MAXPITCH | 370 | 100 | 250 | 350 | 600 |
| MEANDUR | 200 | 150 | 300 | 300 | 170 |
| DURVAR | 100 | 20 | 100 | 150 | 50 |
| PROBACCENT | 0.4 | 0.4 | 0 | 0.2 | 0.3 |
| DEFAULTCONTOUR | RISING | FALLING | FALLING | RISING | RISING |
| CONTOURLASTWORD | RISING | FALLING | FALLING | RISING | RISING |
| VOLUME | 1 | 2 | 1 | 2 | 0 |

### Validation With Human Subjects

In order to evaluate the algorithm described in the above sections, an experiment was conducted in which human subjects were asked to describe the emotion that they felt when hearing a vocalisation produced by the system. footnote{Some sample sounds are available on the associated web page www.csl.sony.fr/py}. More precisely, each subject first listened to 10 examples of vocalisations, with emotion randomly chosen for each example, so that they got used to the voice of the system. Then they were presented a sequence of 30 vocalisations (unsupervised series), each time corresponding to an emotion randomly chosen, and were asked to make a choice between “Calm”, “Anger”, “Sadness”, “Comfort” and “Happiness”.

They could hear each example only once. In a second experiments with different subjects, they were initially given four supervised examples of each emotion, which meant they were presented a vocalisation together with a label of the intended emotion. Again they were presented 30 vocalisations that they had to describe with one of the word cited above. 8 candid adult subjects were present in each experiment: three French subjects, one English subject, one German subject, one Brazilian subject, and two Japanese subjects (none of them was familiar with the research or had special knowledge about the acoustic correlates of emotion in speech). Table III below shows the results-for the unsupervised series experiment. The number in the (rowEm,columnEm) indicates the percentage of times a vocalisation intended to represent rowEm emotion was perceived as columnEm emotion. For instance in the Table III, it can be observed that 76 percent of vocalisations intended to represent sadness were effectively perceived as such.

The results of the unsupervised series experiment have to be compared with experiments conducted with human speech instead of machine speech. These show that for similar set-ups, like in (Tickle A. 2000 “English and Japanese speaker's emotion vocalisations and recognition: a comparison highlighting vowel quality”, ISCA Workshop on Speech and Emotion Recognition, Belfast 2000) in which humans were asked to produce nonsense emotional speech, that at best humans have 60 percent success, and most often less. Here it is observed that the mean result is 57 percent, which compares well with human performance. Looking closer at the results, it ca be seen that the errors are most of the time not “bad” errors, especially about the degree of arouseness in the speech: happy is confused most often with anger (both are aroused), and calm is confused most often with sad and comfort (they are not aroused). In fact, less than 5 percent of errors are made on the degree of arouseness. Finally, it can be observed that many errors involve the calm/neutral affect. This led to a second unsupervised experiment, similar to the one reported here except that the calm affect was removed.

A mean success of 75 percent was obtained, which is a great increase and is much better than human performance. This can be explained in part by the fact that here the acoustical correlates of emotions are exaggerated. The results presented here are similar to those reported in (Breazal 2000), which proves that using a concatenative synthesiser with a lot fewer parameters still allows to convey emotions (and in general provides more life-like sounds).

TABLE III
Confusion matrix for the unsupervised series

| | Calm | Anger | Sadness | Comfort | Happiness |
|---|---|---|---|---|---|
| Calm | 36 | 1 | 1 | 30 | 30 |
| Anger | 0 | 65 | 0 | 0 | 35 |
| Sadness | 20 | 0 | 76 | 4 | 0 |
| Comfort | 45 | 0 | 16 | 39 | 0 |
| Happiness | 5 | 30 | 0 | 5 | 60 |

Examination of the supervised series shows that the presentation of only very few vocalisations with their intended emotion (4 exactly for each emotion), results increase greatly: now 77 percent success is achieved. Again the few errors are not “bad”. Similarly, an experiment removing the calm affect was conducted, which gave a mean success of 89 percent. This supervision is something that can be implemented quite easily with digital pets: many of them use for e.g. combinations of color LED lights to express their “emotions”, and the present experiment shows that it would be sufficient to visually see the robot a few times while it is uttering emotional sentences to be able later to recognise its intended emotion just by listening to it.

TABLE IV
Confusion matrix for the supervised series

| | Calm | Anger | Sadness | Comfort | Happiness |
|---|---|---|---|---|---|
| Calm | 7.6 | 3 | 4 | 14 | 3 |
| Anger | 0 | 92 | 0 | 0 | 8 |
| Sadness | 8 | 0 | 76 | 16 | 0 |
| Comfort | 15 | 0 | 5 | 77 | 3 |
| Happiness | 4 | 20 | 0 | 8 | 68 |

FIG. 2 shows how these emotions are positioned in a chart which represents an “emotional space”, in which the parameters “valence” and “excitement” are expressed respectively along vertical and horizontal axes 2 and 4. The valence axis ranges from negative to positive values, while the excitement axis ranges from low to high values. The cross-point O of these axes is at the centre of the chart and corresponds to a calm/neutral state. From that point are defined four quadrants, each containing an emotional state, as follows: happy/praising (quadrant Q1) characterised by positive valence and high excitement, comfort/soothing (quadrant Q2) characterised by positive valence and low excitement, sad (quadrant Q3) characterised by negative valence and low excitement, and angry/admonishing (quadrant Q4) characterised by negative valence and high excitement.

### Preferred Embodiments of the Present Invention

The method and device in accordance with the invention are a development of the above concepts. The idea resides in controlling at least one of the pitch contour, the intensity contour and the rhythm of a phrase produced by voice synthesis. The inventive approach is relatively exhaustive and can easily be reproduced by other workers. In particular, the preferred embodiments are developed from freely available software modules that are well documented, simple to use and for which there are many equivalent technologies. Accordingly, the modules produced by these embodiments of the invention are totally transparent.

The embodiments allow a total, or at a least high degree of control of pitch contour, rhythm (duration of phonemes), etc.

Conceptually, the approach is more general than in the Applicants earlier priority European patent application.

The approach in accordance with the present invention is based on considering a phrase as a succession of syllables. The phrase can be speech in a recognised language, or simply meaningless utterances. For each syllable, it is possible to fully control the contour of the pitch (f0), optionally the intensity contour (volume), and the duration of the syllable. However, at least the control of the intensity is not necessary, as a modification in the pitch can give the impression of a change in intensity.

The problem is then to determine these contours—pitch contour, duration, and possibly intensity contour—throughout a sentence so as to produce an intonation that corresponds to a given emotion.

The concept behind the solution is to start off from a phrase having a set contour (f0)), a set intensity and a set duration for each syllable. This reference phrase can be produced either from a voice synthesiser for a recognised language, giving an initial contour (f0), an initial duration (t) and possibly an initial intensity. Alternatively, the reference phrase can be meaningless utterances, such as babble from infants. In this case, there is initially attributed a “flat” pitch contour (f0) at a set initial value, a “flat” intensity contour at set initial value, and a “fixed” duration (t) at a set initial value. These characteristics are set out in a specific format readable by a voice synthesiser.

The data supplied to a voice synthesiser is formatted according to a set protocol. For example, each syllable to by synthesised can be encoded as follows (case of syllable “be”, characterised in terms of a duration and five successive pitch values within that duration):

Identification of syllable: “be”; duration (milliseconds) t1=100; pitch data (Hz)—first portion P1=80, second portion P2=100, third portion P3=120, fourth portion P4=90, fifth portion P5=230.

The above data is contained in a frame simply by encoding the parameters: be; 100, 80, 100, 120, 90, 230, each being identified by the synthesiser according to the protocol.

FIG. 3 shows the different stages by which these digital data are converted into a synthesised sound output.

Initially, a voice message is composed in terms of a succession of syllables to be uttered. The message can be intelligible words forming grammatical sentences conveying meaning in a given recognised language, or meaningless sounds such a babble, animal-like sounds, or totally imaginary sounds. The syllables are encoded in the above-described digital data format in a vocalisation data file 10.

A decoder 12 reads out the successive syllable data from the data file 10.

FIG. 4a shows graphically how these data are organised by the decoder 12 in terms of a coordinate grid with pitch fundamental frequency (in Hertz) along the ordinate axis and time (in milliseconds) along the abscissa. The area of the grid is divided into five columns corresponding to each of the five respective durations, as indicated by the arrowed lines. At the centre of each column is placed the pitch value, as defined by the corresponding pitch data, against the scale on the ordinate.

The syllable data are transferred to an interpolator 14 which produces from the five elementary pitch values P1-P5 a close succession of interpolated pitch values, using standard interpolation techniques. The result is a relatively smooth curve of the evolution of pitch over the 100 ms duration of the syllable “be”, as shown in FIG. 4b. The process is repeated for each inputted syllable data, to produce a continuous pitch curve over successive syllables of the phrase.

The pitch waveform thus produced by the interpolator is supplied to an audio frequency sound processor 16 which generates a corresponding modulated amplitude audio signal. The sound processor may also add some random noise to the final audio signal to give a more realistic effect to the synthesised sound, as explained above. This final audio signal is supplied to an audio amplifier 18 where its level is raised to a suitable volume, and then outputted on a loudspeaker 20 which thus reproduces the synthesised sound data from vocalisation data file 10.

If the vocalisation data file 10 contains intelligible phrases, part of the syllable data associated with the syllables will normally include an indication of which syllables may be accentuated to give a more naturally sounding delivery.

As is normally the case, the pitch values contained in the syllable data correspond to a “neutral” form of speech, i.e. not charged with a discernible emotion.

FIG. 5 is a block diagram showing in functional terms how an emotion generator 22 of the preferred embodiment integrates with the synthesiser 1 shown in FIG. 3.

The emotion generator 22 operates by selectively applying operators on the syllable data read out from the vocalisation data file 10. Depending on their type, these operators can modify either the pitch data (pitch operator) or the syllable duration data (duration operator). These modifications take place upstream of the interpolator 14, e.g. before the decoder 12, so that the interpolation is performed on the operator-modified values. As explained below, the modification is such as to transform selectively a neutral form of speech into a speech conveying a chosen emotion (sad, calm, happy, angry) in a chosen quantity.

The basic operator forms are stored in an operator set library 24, from which they can be selectively accessed by an operator set configuration unit 26. The latter serves to prepare and parameterise the operators in accordance with current requirements. To this end, there is provided a operator parameterisation unit 28 which determines the parameterisation of the operators in accordance with both: i) the emotion to be imprinted on the voice (calm, sad, happy, angry, etc.), ii) possibly the degree—or intensity—of the emotion to apply, and iii) the context of the syllable, as explained below. The emotion and degree of emotion are instructed to the operator parameterisation unit 28 by an emotion selection interface 30 which presents inputs accessible to a user 32. The emotion selection interface can be in the form of a computer interface with on-screen menus and icons, allowing the user 32 to indicate all the necessary emotion characteristics and other operating parameters.

In the example, the context of the syllable which is operator sensitive is: i) the position of syllable in a phrase, as some operator sets are applied only to the first and last syllables of the phrase, ii) whether the syllables relate to intelligible word sentences or to unintelligible sounds (babble, etc.) and iii) as the case arises, whether or not a syllable considered is allowed or not to be accentuated, as indicated in the vocalisation data file 10.

To this end, there is provided a first and last syllables identification unit 34 and an authorised syllable accentuation detection unit 36, both having an access to the vocalisation data file unit 10 and informing the operator parameterisation unit 28 of the appropriate context sensitive parameters.

As detailed below, there are operator sets which are applicable specifically to syllables that are to be accentuated (“accentuable” syllables). These operators are not applied systematically to all accentuable syllables, but only to those chosen by a random selection among candidate syllables. The candidate syllables depend on the vocalisation data. If the latter contains indications of which syllables are allowed to be accentuated, then the candidate syllables are taken only among those accentuable syllables. This will usually be the case for intelligible texts, where some syllables are forbidden from accentuation to ensure a naturally-sounding delivery. If the vocalisation library does not contain such indications, then all the syllables are candidates for the random selection. This will usually be the case for unintelligible sounds.

The random selection is provided by a controllable probability random draw unit 38 operatively connected between the authorised syllable accentuation unit 36 and the operator parameterisation unit 28. The random draw unit 38 has a controllable degree of probability of selecting a syllable from the candidates. Specifically, if N is the probability of a candidate being selected, with N ranging controllably from 0 to 1, then for P candidate syllables, N.P syllables shall be selected on average for being subjected to a specific operator set associated to a random accentuation. The distribution of the randomly selected candidates is substantially uniform over the sequence of syllables.

The suitably configured operator sets from the operator set configuration unit 26 are sent to a syllable data modifier unit 40 where they operate on the syllable data. To this end, the syllable data modifier unit 40 receives the syllable data directly from vocalisation data file 10, in a manner analogous to the decoder 12 of FIG. 3. The thus-received syllable data are modified by unit 40 as a function of the operator set, notably in terms of pitch and duration data. The resulting modified syllable data (new syllable data) are then outputted by the syllable data modifier unit 40 to the decoder 12, with the same structure as presented in the vocalisation data file (cf. FIG. 2a). In this way, the decoder can process the new syllable data exactly as if it originated directly from the vocalisation data file. From there, the new syllable data are interpolated (interpolator unit 14) and processed by the other downstream units of FIG. 3 in exactly the same way. However, the sound produced at the speaker then no longer corresponds to a neutral tone, but rather to the sound with a simulation of an emotion as defined by the user 32.

All the above functional units are under the overall control of an operations sequencer unit 42 which governs complete execution of the emotion generation procedure in accordance with a prescribed set of rules.

FIG. 6 illustrates graphically the effect of the pitch operator set OP on a pitch curve (as in FIG. 4b) of a synthesised sound. For each operator, the figure shows—respectively on left and right columns—a pitch curve (fundamental frequency f against time t) before the action of the pitch operator and after the action of a pitch operator. In the example, the input pitch curves are identical for all operators and happen to be relatively flat.

There are four operators in the illustrated set, as follows (from top to bottom in the figure):

a “rising slope” pitch operator OPrs, which imposes a slope rising in time on any input pitch curve, i.e. it causes the original pitch contour to rise in frequency over time;

a “falling slope” pitch operator OPfs, which imposes a slope falling in time on any input pitch curve, i.e. it causes the original pitch contour to fall in frequency over time;

a “shift-up” pitch operator OPsu, which imposes a, uniform upward shift in fundamental frequency on any input pitch curve, the shift being the same for all points in the time, so that the pitch contour is simply moved up the fundamental frequency axis; and

a “shift-down” pitch operator OPsd, which imposes a uniform downward shift in fundamental frequency on any input pitch curve, the shift being the same for all points in the time, so that the pitch contour is simply moved down the fundamental frequency axis.

In the embodiment, the rising slope and falling slope operators OPrs and OPfs have the following characteristic: the pitch at the central point in time (½ t1 for a pitch duration of t1) remains substantially unchanged after the operator. In other words, the operators act to pivot the input pitch curve about the pitch value at the central point in time, so as to impose the required slope. This means that in the case of a rising slope operator OPrs, the pitch values before the central point in time are in fact lowered, and that in the case of a falling slope operator OPfs, the pitch values before the central point in time are in fact raised, as shown by the figure.

Optionally, there can also be provided intensity operators, designated OI. The effects of these operators are shown in FIG. 7, which is directly analogous to the illustration of FIG. 6. These operators are also four in number and are identical to those of the pitch operators OP, except that they act on the curve of intensity I over time t. Accordingly, these operators shall not be detailed separately, for the sake of conciseness.

The pitch and intensity operators can each be parameterised as follows:

for the rising and falling operators (OPrs, OPfs, OIrs, OIfs): the gradient of slope to be imposed on the input contour. The slope can be expressed in terms of normalised slope values. For instance, 0 corresponds to no slope imposed: the operator in this case has no effect on the input (such an operator is referred to a neutralised, or neutral, operator). At the other extreme, a maximum value max causes the input curve to have an infinite gradient i.e. to rise or fall substantially vertically. Between these extremes, any arbitrary parameter value can be associated to the operator in question to impose the required slope on the input contour;

for the shift operators (OPsu, OPsd, OIsu, OIsd): the amount of shift up or down imposed on the input contour, in terms of absolute fundamental frequency (for pitch) or intensity values. The corresponding parameters can thus be expressed in terms of a unit increment or decrement along the pitch or intensity axis.

FIG. 8 illustrates graphically the effect of a duration (or time) operator OD on a syllable. The illustration shows on left and right columns respectively the duration of the syllable (in terms of a horizontal line expressing an initial length of time t1) of the input syllable before the effect of a duration operator and after the effect of a duration operator.

The duration operator can be:

a dilation operator which causes the duration of the syllable to increase. The increase is expressed in terms of a parameter D, referred to as a positive D parameter). For instance, D can simply be a number of milliseconds of duration to add to the initial input duration value if the latter is also expressed in milliseconds, so that the action of the operator is obtained simply by adding the value D to duration specification t1 for the syllable in question. As a result, the processing of the data by the interpolator 14 and following units will cause the period over which the syllable is pronounced to be stretched;

a contraction operator which causes the duration of the syllable to increase. The decrease is expressed in terms of the same parameter D, being negative parameter in this case). For instance, D can simply a number of milliseconds of duration to subtract from the initial input duration value if the latter is also expressed in milliseconds, so the action of the operator is obtained simply by subtracting the value D from the duration specification for the syllable in question. As a result, the processing of the data by the interpolator 14 and following units will cause the period over which the syllable is pronounced to be contracted (shortened).

The operator can also be neutralised or made as a neutral operator, simply by inserting the value 0 for the parameter D.

Note that while the duration operator has been represented as being of two different types, respectively dilation and contraction, it is clear that the only difference resides in the sign plus or minus placed before the parameter D. Thus, a same operator mechanism can produce both operator functions (dilation and contraction) if it can handle both positive and negative numbers.

The range of possible values for D and its possible incremental values in the range can be chosen according to requirements.

In what follows, the parameterisation of each of the operators OP, OI and OD is expressed by a variable value designated by the last letters of the specific operator plus the suffix specific to each operator, i.e.: Prs=value of the positive slope parameter for rising slope pitch operator OPrs; Pfs=value of the negative slope parameter for the falling slope pitch operator OPfs; Psu=value of the amount of upward shift for the shift-up pitch operator OPsu; Psd=value of the downward shift pitch operator OPsd; Dd=value of the time increment for the duration dilation operator ODd; Dc value of the time decrement (contraction) for the duration contraction operator ODc.

The embodiment further uses a separate operator, which establishes the probability N for the random draw unit 38. This value is selected from a range of 0 (no possibility of selection) to 1 (certainty of selection). The value N serves to control the density of accentuated syllables in the vocalised output as appropriate for the emotional quality to reproduce.

FIGS. 9A and 9B constitute a flow chart indicating the process of forming and applying selectively the above operators to syllable data on the basis of the system described with reference to FIG. 5. FIG. 9B is a continuation of FIG. 9A.

The process starts with an initialisation phase P1 which involves loading input syllable data from the vocalisation data file 10 (step S2). The data appear as an identification of the syllable e.g. “be”, followed by a first value t1 expressing the normal duration of the syllable, followed by five values P1 to P5 indicating the fundamental frequency of the pitch at five successive intervals of the indicated duration t1, as explained with reference to FIG. 4a.

Next is loaded the emotion to be conveyed on the phrase or passage of which the loaded syllable data forms a part, using the interface unit 30 (step S4). The emotions can be calm, sad, happy, angry, etc. The interface also inputs the degree of emotion to be given, e.g. by attributing a weighting value (step S6).

The system then enters into a universal operator phase P2, in which a universal operator set OS(U) is applied systematically to all the syllables. The universal operator set OS(U) contains all the operators of FIGS. 6 and 8, i.e. OPrs, OPfs, OPsu, OPsd, forming the four pitch operators, plus ODd and ODc, forming the two duration operators. Each of these operators of operator set OS(U) is parameterised by a respective associated value, respectively Prs(U), Pfs(U), Psu(U), Psd(U), Dd(U), and Dc(U), as explained above (step S8). This step involves attributing numerical values to these parameters, and is performed by the operator set configuration unit 26. The choice of parameter values for the universal operator set OS(U) is determined by the operator parameterisation unit 8 as a function of the programmed emotion and quantity of emotion, plus other factors as the case arises.

The universal operator set OS(U) is then applied systematically to all the syllables of a phrase or group of phrases (step S10). The action involves modifying the numerical values t1, P1-P5 of the syllable data. For the pitch operators, the slope parameter Prs or Pfs are translated into a group of five difference values to be applied arithmetically to the values P1-P5 respectively. These difference values are chosen to move each of the values P1-P5 according the parameterised slope, the middle value P3 remaining substantially unchanged, as explained earlier. For instance, the first two values of the rising slope parameters will be negative to cause the first half of the pitch to be lowered and the last two values will be positive to cause the last half of the pitch to be raised, so creating the rising slope articulated at the centre point in time, as shown in FIG. 6. The degree of slope forming the parameterisation is expressed in terms of these difference values. A similar approach in reverse is used for the falling slope parameter.

The shift up or shift down operators can be applied before or after the slope operators. They simply add or subtract a same value, determined by the parameterisation, to the five pitch values P1-P5. The operators form is mutually exclusive pairs, i.e. a rising slope operator will not be applied if a falling slope operator is to be applied, and likewise for the shift up and down and duration operators.

The application of the operators (i.e. calculation to modify the data parameters t1, P1-P5) is performed by the syllable data modifier unit 40.

Once the syllables have thus been processed by the universal operator set OS(U), they are provisionally buffered for further processing if necessary.

The system then enters into a probabilistic accentuation phase P2, for which another operator accentuation parameter set OS(PA) is prepared. This operator set has the same operators as the universal operator set, but with different values for the parameterisation. Using the convention employed for the universal operator set, the operator set OS(PA) is parameterised by respective values: Prs(PA), Pfs(PA), Psu(PA), Psd(PA), Dd(PA), and Dc(PA). These parameter values are likewise calculated by the operator parameterisation unit 28 as a function of the emotion, degree of emotion and other factors provided by the interface unit 30. The choice of the parameters is generally made to add a degree of intonation (prosody) to the speech according to the emotion considered. An additional parameter of the probabilistic accentuation operator set OS(PA) is the value of the probability N, as defined above. This value depends on the emotion and degree of emotion, as well as other factors, e.g. the nature of the syllable file.

Once the parameters have been obtained, they are entered into the operator set configuration unit 26 to form the complete probabilistic accentuation parameter set OS(PA) (step S12).

Next is determined which of the syllables is to be submitted to this operator set OS(PA), as determined by the random unit 38 (step S14). The latter supplies the list of the randomly drawn syllables for accentuating by this operator set. As explained above, the candidate syllables are:

all syllables if dealing with unintelligible sounds or if there are no prohibited accentuations on syllables, or

only the allowed (accentuable) syllables if these are specified in the file. This will usually be the case for meaningful words.

The randomly selected syllables among the candidates are then submitted for processing by the probabilistic accentuation operator set OS(PA) by the syllable data modifier unit 40 (step S16). The actual processing performed is the same as explained above for the universal operator set, with the same technical considerations, the only difference being in the parameter values involved.

It will be noted that the processing by the probabilistic accentuation operator set OS(PA) is performed on syllable data that has already been processed by the universal operator set OS(U). Mathematically, this fact can be presented as follows, for a syllable data item Si of the file processed after having been drawn at step S14: OS(PA).OS(U). Si→Sipacc, where Sipacc is the resulting data for the accentuated processed syllable.

For all but the syllables of the first and last words of a phrase contained in the vocalisation data file unit 10, the syllable data modifier unit 40 will supply the following modified forms of the syllable data (generically denoted S) originally in the file 10:

OS(U).S→Spna for the syllable data that have not been drawn at step S14, Spna designating a processed non-accentuated syllable, and

OS(PA).OS(U). S→Spacc for the syllable data that have been drawn at step S14, Spacc designating a processed accentuated syllable.

Finally, the process enters into a phase P4 of processing an accentuation specific to the first and last syllables of a phrase. When a phrase is composed of identifiable words, this phase P4 acts to accentuate all the syllables of the first and last words of the phrase. The term phrase can be understood in the normal grammatical sense for intelligible text to be spoken, e.g. in terms of pauses in the recitation. In the case of unintelligible sound, such as babble or animal imitations, a phrase is understood in terms of a beginning and end of the utterance, marked by a pause. Typically, such a phrase can last from around one to three or to four seconds. For unintelligible sounds, the phase P4 of accentuating the last syllables applies to at least the first and last syllables, and preferably the first m and last n syllables, where m or n are typically equal to around 2 or 3 and can be the same or different.

As in the previous phases, there is performed a specific parameterisation of the same basic operators OPrs, OPfs, OPsu, OPsd, ODd, ODc, yielding a first and last syllable accentuation operator set OS(FL) parameterised by a respective associated value, respectively Prs(FL), Pfs(FL), Psu(FL), Psd(FL), Dd(FL), and Dc(FL) (step S18). These parameter values are likewise calculated by the operator parameterisation unit 28 as a function of the emotion, degree of emotion and other factors provided by the interface unit 30.

The resulting operator set OS(FL) is then applied to the first and last syllables of each phrase (step S20), these syllables being identified by the first/last syllables detector unit 34.

As above, the syllable data on which is applied operator set OS(FL) will have previously been processed by the universal operator set OS(U) at step S10. Additionally, it may happen that a first or last syllable(s) would also been drawn at the random selection step S14 and thereby also be processed with by probabilistic accentuation operator set OS(PA).

There are thus two possibilities of processing for a first or last syllable, expressed below using the convention defined above:

possibility one: processing by operator set OS(U) and then by operator set OS(FL), giving: OS(FL).OS(U).S→Spfl(1), and

possibility two: processing successively by operator set OS(U), OS PA) and OS(FL), giving; OS(FL).OS(PA).OS(U).S→Spfl(2).

This simple operator-based approach has been found to yield results at least comparable to those obtained by much more complicated systems, both for meaningless utterances and in speech in a recognisable language.

The choice of parameterisations to express a given emotion is extremely subjective and varies considerably depending on the form of utterance, language, etc. However, by virtue of having simple, well-defined parameters that do not require much real-time processing, it is a simple to scan through many possible combinations of parameterisations to obtain the most satisfying operator sets.

Merely to give an illustrative example, the Applicant has found the that good results can be obtained with the following parameterisations:

Sad: pitch for universal operator set=falling slope with small inclination

duration operator=dilation

probability of draw N for accentuation: low

Calm: no operator set applied, or only lightly parameterised universal operator

Happy: pitch for universal operator set=rising slope, moderately high inclination

duration for universal operator set=contraction

duration for accentuated operator set=dilation

Angry: pitch for all operator sets=falling slope, moderately high inclination

duration for all operator sets=contraction.

For an operator set not specified in the above example, the parameterisation of the same general type for all operator sets. Generally speaking, the type of changes (rising slope, contraction, etc.) is the same for all operator sets, only the actual values being different. Here, the values are usually chosen so that the least amount of change is produced by the universal operator set, and the largest amount of change is produced by the first and last syllable accentuation, the probabilistic accentuation operator set producing an intermediate amount of change.

The system can also be made to use intensity operators OI in its set, depending on the parameterisation used.

The interface unit 30 can be integrated into a computer interface to provide different controls. Among these can be direct choice of parameters of the different operator sets mentioned above, in order to allow the user 32 to fine-tune the system. The interface can be made user friendly by providing visual scales, showing e.g. graphically the slope values, shift values, contraction/dilation values for the different parameters.

Also, it is clear that the division of elementary operators shown in FIGS. 6, 7 and 8 and used in the process of FIGS. 9a and 9b was made in view of rendering the disclosure more readily understandable. In practice, complementary pairs operators such as rising and falling slope operators can be combined into one single operator that can impose either rising or falling slopes depending on its parameterisation. Likewise, the shift up and shift down operators can be combined into just one operator which can shift the pitch or intensity contour up or down depending on its parameterisation. The same also holds for the duration operators, as already mentioned above.

The examples are illustrated for a given format of speech data, but is clear that any other formatting of data can be accommodated. The number of pitch or intensity values given in the examples can be different from 5, typical numbers of values ranging from just one to more than five.

While the invention has been described on the basis of prestored numerical data representing the voice to be synthesised, it can also be envisaged for a system processing electronic signals of utterances, either in digital or analog form. In this case, the operators can act on directly on the pitch, intensity, or amplitude waveforms. This can be achieved by digital sound processing or by analog circuitry, such as ramp generators, level shifters, delay lines, etc.

The embodiment can be implemented in a large variety of devices, for instance: robotic pets and other intelligent electronic creatures, sound systems for educational training, studio productions (dubbing, voice animations, narration, etc.), devices for reading out loud texts (books, articles, mail, etc.), sound experimentation systems (psycho-acoustic research etc), humanised computer interfaces for PCs, instruments and other equipment, and in other applications, etc. . . .

The form of the embodiment can range from a stand-alone unit fully equipped to provide a complete synthesised sound reproduction (cf. FIG. 3), an accessory operational with existing sound synthesising, or in the form of software modules recorded on a medium or in downloadable form to be run on adapted processor systems.

1. Method of synthesising an emotion conveyed on a sound, by selectively modifying at least one elementary sound portion (S) thereof prior to delivering the sound,
characterised in that said modification is produced by an operator application step (S10, S16, S20) in which at least one operator (OP, OD; OI) is selectively applied to at least one said elementary sound portion (S) to impose a specific modification in a characteristic thereof in accordance with an emotion to be synthesised.

2. Method according to claim 1, wherein said characteristic comprises at least one of:
pitch, and
duration
of said elementary sound portions (S).

3. Method according to claim 2, wherein said operator application step (S10, S16, S20) comprises forming at least one set of operators (OS(U), OS(PA), OS(FL)), said set comprising at least one operator (OPrs, OPfs, OPsu, OPsd) to modify a pitch characteristic and/or at least one operator (ODd, ODc) to modify a duration characteristic of said elementary sound portions (S).

4. Method according to any one of claims 1 to 3, wherein said operator application step (S10, S16, S20) comprises applying at least one operator (OIrs, OIfs, OIsu, OIsd) to modify an intensity characteristic of said elementary sound portions.

5. Method according to any one of claims 1 to 4, further comprising, a step (S8, S12, S18) of parameterising at least one said operator (OP, OI, OD) with a numerical parameter affecting an amount of a said specific modification associated to said operator in accordance with an emotion to be synthesised.

6. Method according to any one of claims 1 to 5, wherein said operator application step (S10, S16, S20) comprises applying an operator (OPrs, OPfs) for selectively causing the time evolution of the pitch of an elementary sound portion (S) to rise or fall according to an imposed slope characteristic (Prs, Pfs).

7. Method according to any one of claims 1 to 6, wherein said operation application step (S10, S16, S20) comprises applying an operator (OPsu, OPsd) for selectively causing the time evolution of the pitch of an elementary sound portion (S) to rise or fall uniformly by a determined value (Psu, Psd).

8. Method according to any one of claims 1 to 7, wherein said operation application step (S10, S16, S20) comprises applying an operator (ODd, ODc) for selectively causing the duration (t1) of an elementary sound portion (S) to increase or decrease by a determined value (D).

9. Method according to any one of claims 1 to 8, comprising a universal phase (P2) in which at least one said operator (OP(U), OD(U)) is applied (S10) systematically to all elementary sound portions (S) forming a determined sequence of said sound.

10. Method according to claim 9, wherein said at least one operator (OP(U), OD(U)) is applied with a same operator parameterisation (S8) to all elementary sound portions (S) forming a determined sequence of said sound.

11. Method according to any one of claims 1 to 10, comprising a probabilistic accentuation phase (P3) in which at least one said operator (OP(PA), OD(PA)) is applied (S16) only to selected elementary sound portions (S) chosen to be accentuated.

12. Method according to claim 11, wherein said selected elementary sound portions (S) are selected by a random draw (S14) from candidate elementary sound portions (S).

13. Method according to claim 12, wherein said random draw selects elementary sound portions (S) with a probability (N) which is programmable.

14. Method according to claim 12 or 13, wherein said candidate elementary sound portions are:
all elementary sound portions when a source (10) of said portions does not prohibit an accentuation on some data portions, or
only those elementary sound portions that are not prohibited from accentuation when said source (10) prohibits accentuations on some data portions.

15. Method according to any one claims 11 to 14 wherein a same operator parameterisation (S12) is used for said at least one operator (OP(PA), OD(PA) applied in said probabilistic accentuation phase (P3).

16. Method according to any one of claims 1 to 15, comprising a first and last elementary sound portions accentuation phase (S4) in which at least one said operator (OP(FL), OD(FL)) is applied (S10) only to a group of at least one elementary sound portion forming the start and end of said determined sequence of sound.

17. Method according to any one of claims 9 to 16, wherein said determined sequence of sound is a phrase.

18. Method according to any one of claims 1 to 17, wherein said elementary portions of sound (S) corresponds to a syllable or to a phoneme.

19. Method according to any one of claims 1 to 18, wherein said elementary sound portions correspond to intelligible speech.

20. Method according to any one of claims 1 to 19, wherein said elementary sound portions correspond to unintelligible sounds.

21. Method according to any one of claims 1 to 20, wherein said elementary sound portions are presented as formatted data values specifying a duration (t1) and/or at least one pitch value (P1-P5) existing over determined parts of or all said duration of said elementary sound.

22. Method according to claim 20, wherein said operators (OP, OP, OD) act to selectively modify said data values.

23. Method according to claim 21 or 22, performed without changing the data format of said elementary sound portion data and upstream of an interpolation stage (14), whereby said interpolation stage can process data modified in accordance with an emotion to be synthesised in the same manner as for data obtained from an arbitrary source (10) of elementary sound portions (S).

24. Device for synthesising an emotion conveyed on a sound, using means for selectively modifying at least one elementary sound portion (S) thereof prior to delivering the sound,
characterised in that said means comprise operator application means (22) for applying (S10, S16, S20) at least one operator (OP, OD; OI) to at least one said elementary sound portion (S) to impose a specific modification in a characteristic thereof in accordance with an emotion to be synthesised.

25. Device according to claim 24, wherein said operator application means (22) comprises means (26, 28) for forming at least one set of operators (OS(U), OS(PA), OS(FL)), said set comprising at least one operator (OPrs, OPfs, OPsu, OPsd) to modify a pitch characteristic and/or at least one operator (ODd, ODc) to modify a duration characteristic of said elementary sound portions (S).

26. Device according to any one of claims 24 or 25, comprising an operator (OPrs, OPfs) for selectively causing the time evolution of the pitch of an elementary sound portion (S) to rise or fall according to an imposed slope characteristic (Prs, Pfs).

27. Device according to any one of claims 24 to 26, comprising an operator (OPsu, OPsd) for selectively causing the time evolution of the pitch of an elementary sound portion (S) to rise or fall uniformly by a determined value (Psu, Psd).

28. Device according to any one of claims 24 to 27, comprising an operator (ODd, ODc) for selectively causing the duration (t1) of an elementary sound portion (S) to increase or decrease by a determined value (D).

29. Device according to any one of claims 24 to 28, operative to conduct at least one of the following three stages:
i) a universal phase (P2) in which at least one said operator (OP(U), OD(U)) is applied (S10) systematically to all elementary sound portions (S) forming a determined sequence of said sound;
ii) a probabilistic accentuation phase (P3) in which at least one said operator (OP(PA), OD(PA)) is applied (S16) only to selected elementary sound portions (S) chosen to be accentuated; and
iii) a first and last elementary sound portions accentuation phase (S4) in which at least one said operator (OP(FL), OD(FL)) is applied (S10) only to a group of at least one elementary sound portion forming the start and end of said determined sequence of sound.

30. Device according to any one of claims 24 to 29, wherein said operator application means (22) operate on externally supplied formatted data values specifying a duration (t1) and/or at least one pitch value (P1-P5) existing over determined parts of or all said duration of said elementary sound.

31. Device according to claim 30, wherein said operator application means (22) operate without changing the data format of said elementary sound portion data and upstream of an interpolation stage (14), whereby said interpolation stage can process data modified in accordance with an emotion to be synthesised in the same manner as for data obtained from an arbitrary source (10) of elementary sound portions (S).

32. A data medium comprising software module means for executing the method according to any one of claims 1 to 23.
